(19) United States
(12) Patent Application Publication
(10) Pub. No.: US 2007/0171994 A1
(43) Pub. Date: Jul. 26, 2007

(54) METHODS FOR DATA TRANSMISSION

(75) Inventors: Steve Carl Jamieson Parker, Bristol (GB); Justin Coon, Bristol (GB)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 11/534,823

(22) Filed: Sep. 25, 2006

(30) Foreign Application Priority Data
Jan. 26, 2006 (GB) 0601620.8

(51) Int. Cl. H04K 1/10

(52) U.S. Cl. 375/260

(57) ABSTRACT

This invention relates to methods for data transmission in OFDM (Orthogonal Frequency Division Multiplexed) communication systems. More particularly, it relates to data transmission in multi-band OFDM (MB-OFDM) systems. The method of generating an OFDM signal for transmission, comprises the steps of: dividing a plurality of subcarriers into two or more groups of subcarriers, minimising the peak-average power ratio (PAPR) of an OFDM signal, and enhancing the transmission of said OFDM signal by further repeating transmission of said OFDM signal.

### FIELD OF THE INVENTION

This invention relates to apparatus and methods for data transmission in Orthogonal Frequency Division Multiplexed (OFDM) communication systems. More particularly, it relates to data transmission in multi-band OFDM (MB-OFDM) systems.

### BACKGROUND OF THE INVENTION

OFDM is a well-known technique for transmitting high bit rate digital data signals. Rather than modulate a single carrier with the high speed data, the data is divided into a number of lower data rate channels each of which is transmitted on a separate subcarrier. In this way, ISI is reduced, because the symbol period is increased relative to the delay spread of the channel. In an OFDM signal the separate subcarriers are spaced so that they overlap, as shown for subcarriers 12 in spectrum 10 of FIG. 1. The subcarrier frequencies are chosen so that the subcarriers are mutually orthogonal, so that the separate signals modulated onto the subcarriers can be recovered at the receiver. One OFDM symbol is defined by a set of symbols, one modulated onto each subcarrier (and therefore corresponds to a plurality of data bits). The subcarriers are orthogonal if they are spaced apart in frequency by an interval of 1/T, where T is the OFDM symbol period not including the duration of the cyclic prefix.

An OFDM symbol can be obtained by performing an inverse Fourier transform, preferably an Inverse Fast Fourier Transform (IFFT), on a set of input symbols. The input symbols can be recovered by performing a Fourier transform, preferably a fast Fourier transform (FFT), on the OFDM symbol. The FFT effectively multiplies the OFDM symbol by each subcarrier and integrates over the symbol period T. It can be seen that for a given subcarrier only one subcarrier from the OFDM symbol is extracted by this procedure, as the overlap with the other subcarriers of the OFDM symbol will average to zero over the integration period T.

It should be noted that, because 1/T=Δf, for an OFDM system with N subcarriers the symbol rate on each subcarrier is N times slower than on a single carrier system employing the full bandwidth W. This provides a consequent improvement in channel robustness, over the comparable single carrier system.

Splitting the data over N subcarriers, within a given bandwidth W, results in symbol intervals N times longer than for a single channel with the same data rate, as noted above. When N is sufficiently large, the symbol period T becomes larger than the duration of channel spread, and the effect is to significantly reduce ISI. In general terms, larger symbol intervals mean that, all else being equal, any ISI is spread over fewer symbols. This simplifies equalisation to correct for ISI.

Splitting the data over N subcarriers also provides the scope to distribute redundant coding such as forward error correction over the subcarriers, making the symbol stream more robust to fading at any given frequency.

Thus, OFDM has the potential to provide much greater channel spread resilience for the same data throughput than a single equivalent rate channel.

However, these properties of OFDM are subject to a number of conditions.

One condition is that the receiver and transmitter are perfectly synchronised in terms of clock frequency and timing, to ensure representative sampling of the signal. To address this, it is well known in the art for a data packet to comprise a preamble of known composition, which can be used to synchronise reception (the preamble also enables estimation of the channel transfer function, which is used during equalisation). Similarly, one or more of the subcarriers can be used as pilot channels, carrying known signal patterns to allow the tracking of any drift in frequency of the receiver relative to the transmitter.

Counter-intuitively, it is also a condition that there is minimal channel spread distortion of the signal. Channel spread causes intersymbol interference when echoes of the previous symbol (signal block) reach the receiver at the start of the next symbol, causing signal distortion that might affect FFT decoding of the received signal for recovery of the N subcarriers. Whilst the increased length of symbol interval T reduces the proportion of echo overlap, it does not eliminate it. Thus, although OFDM reduces the degree of overlap between symbols, it is very sensitive to any overlap that remains.

The reflection of signals in the propagation environment is commonplace. To accommodate this problem, it is similarly well known in the art to add a guard interval to the transmitted signal equal to an estimate of the maximum multi-path delay spread. This adds an appreciable overhead to the data transmission rate, which is proportional to the ratio of the delay spread to the symbol period T (e.g., 20% for IEEE 802.11a). The interval is referred to as a cyclic prefix, where a portion of the signal tail is prepended to the signal itself to occupy the interval. In some OFDM systems, where power spectral density is severely limited by the regulatory spectral mask (such as with IEEE 802.15.3a), zero padding is used instead of a cyclic prefix because it can give better performance.

As noted previously, redundancy within the symbol in the form of forward error correction enables recovery of information lost through multipath fading, but again at the cost of an overhead.

A third condition is that there is minimal transmission distortion of the signal that might affect recovery of the N subcarriers. However, prior to transmission, the process of converting the N subcarriers into a waveform via inverse FFT can result in a large peak to average power ratio (PAPR), when signals modulating the OFDM subcarriers add constructively in phase. This in turn can lead to signal distortion when the transmitter contains a non-linear component such as a power amplifier.

The resulting non-linear effects cause intra-band interference due to intermodulation and warping of the signal constellation, and inter-band interference in the form of adjacent channel interference through spectral spreading. Both types of interference increase the bit error rate (BER) at the receiver.

Ultra wideband (UWB) systems are permitted to operate within a very large bandwidth For example, 7.5 GHz is allowed by the FCC in the USA. However, transmissions are vulnerable to interference and have limited range due to restrictions imposed on maximum allowed power spectral density. Again, for example, the FCC allows −41.3 dBm/MHz. Hence, there is a desire to spread signals in frequency, for example by repetition coding, to increase resilience to interference and fading, reduce quantisation errors, and improve range. However, the mean PAPR of OFDM signals increases linearly with the number of subcarriers used. If the PAPR is too high then several problems arise:
Amplification of the OFDM signals becomes non-linear.
Operation of the amplifier ‘backed-off’ results in poor power efficiency.
The amplifier must be capable of linearly amplifying higher power signals, which can prevent complete implementation in complementary metal oxide semiconductor (CMOS).

Hence, the need to limit the PAPR for economic and performance reasons restricts the practical number of subcarriers that may be used for future OFDM UWB systems. Another factor is the complexity growth of the FFT with increasing number of tones. With a desire to increase data rates for high definition television (HDTV), and increase range for domestic wireless local area network (WLAN), there is a need for OFDM UWB systems that use larger numbers of subcarriers, but have an acceptable PAPR to facilitate implementation in CMOS. The use of a larger bandwidth increases the channel capacity available and will therefore inherently improve the potential for increased data rates and extended range. The leading UWB physical (PHY) layer proposal, submitted by the Multi-Band OFDM Alliance (MBOA) for consideration for IEEE 802.15.3a, adopts OFDM and uses frequency spreading for the two lowest rate modes. This is set out in “Multi-band OFDM physical layer proposal for IEEE 802.15 Task Group 3a” (A. Batra et al, IEEE 802.15-03/268r3, March 2004) and “Multi-band OFDM physical layer proposal for IEEE 802.15 Task Group 3a (Update)” (A. Batra et al, IEEE 802.15-04/0493r1, September 2004).

In addition, a subsequent revision to this proposal (“MB-OFDM proposal update” (D. Leeper, IEEE 802.15-05-397r1, July 2005)) uses dual carrier modulation for the higher rate modes to increase frequency diversity to combat frequency selective fading.

In the MBOA proposal for the two lowest rate modes, the stream of Quadrature-PSK (QPSK) information symbols are divided into groups of 50. Each complex value c_{n,k} is then assigned to subcarrier n of the k th OFDM symbol according to:

c_{n,k}=d_{n+50×k} (1)

### Where n=0, 1, . . . , 49 k=0, 1, . . . , N_{sym}−1

The repetition code then repeats the symbol in the following manner:

c_{(n+50),,k}=d*_{(49-n)+50×k} (2)

This relationship mirrors each symbol about the DC tone and phase conjugates it. This mapping is useful because the IFFT of a conjugate symmetric mapping is purely real. Hence, the hardware of the receiver may be simplified. In practice, however, only the simplest devices will exclusively support the lowest rate modes and therefore this property is of limited value.

For the higher rate modes, the MBOA has recently proposed (in A. Batra et al, “Multi-band OFDM physical layer proposal for IEEE 802.15 Task Group 3a (Update)” IEEE 802.15-04/0493r1, September 2004) that 16-QAM signals should be used which essentially encode the information from two separate QPSK symbols for each subcarrier and that identical information is transmitted in a different encoded manner on a second subcarrier positioned 50 subcarriers apart. The rate of the system remains unchanged by this dual carrier modulation, but frequency diversity increases and bit error rate (BER) performance improves because it is unlikely that a deep fade will be experienced on two uncorrelated subcarriers.

The present invention can be used to improve performance for both of these cases by reducing the PAPR of the signals.

Other methods of PAPR reduction have been proposed in the literature (reviewed in S. Han and J. Lee, “An overview of peak-average power ratio reduction techniques for multi-carrier transmission,” IEEE Wireless Communications April 2005, 56-65), but these have associated disadvantages and are not so amenable to OFDM systems with repetition coding or use dual carrier modulation:
Clipping: the peaks of the OFDM time domain waveform may be clipped to reduce the PAPR—this leads to the introduction of both in-band and out-of band noise and makes it harder to satisfy the spectral mask (increased back-off or additional filtering needed).
Coding: an exhaustive search can be used to identify input symbol combinations that lead to signals with a high PAPR. The use of these combinations can then be avoided, although this requires huge exhaustive searches and the use of large look-up tables. In practice, these schemes are limited to systems that use a small number of subcarriers.
Partial transmit sequences: a block of symbols is partitioned into sub-blocks and these are optimally phased with respect to one other to minimise the PAPR. This scheme is exponentially complex in the number of sub-blocks used and therefore there is a performance-complexity trade-off.
Selected mapping technique: several different mappers are assigned to the same set of information and searches are used to determine the best mapping that minimises the PAPR.
Interleaving: a set of interleavers is used to produce a set of equivalent data blocks and the result with the lowest PAPR is chosen. This method requires additional computational complexity, has limited scope for improvement and the receiver must be informed as to which interleaver has been used by the transmitter.
Tone reservation/injection: tones may be dedicated for the purpose of adding a narrowband signal that reduces peaks in the time domain signal. This method reduces the size of the available payload and increases computational complexity to find the correct tone to inject.
Active constellation extension: The position of constellation points can be migrated outwards in the complex plane to minimise the PAPR. However, this method increases transmit power and it is most suited to large constellation sizes, both of which are restrictive for UWB.

### SUMMARY OF THE INVENTION

The present invention aims to minimise the PAPR of a transmitted OFDM signal while ameliorating one or more of the problems identified above.

In a first aspect of the present invention, there is provided a method of generating an OFDM signal for transmission, the signal being intended for transmission over a plurality of subcarriers, the method comprising the steps of:
allocating said plurality of subcarriers into two groups of subcarriers, and:
   allocating information for transmission to a first of said groups;
   transposing said allocated information by means of a transposition algorithm; and
   allocating to a second of said groups said transposed allocated information.

Preferably, said subcarriers are designated in the frequency domain.

The first and second groups of subcarriers may be disposed symmetrically about a DC baseband carrier in the frequency domain.

Said step of transposing may comprise allocating to one of the subcarriers in the second group of subcarriers the information allocated to a first one of the subcarriers in the first group. In this case, preferably, the step of transposing said information from said first subcarrier comprises the step of rendering said information into its additive inverse, that is, its negative.

Said step of transposing may further comprise allocating to another of the subcarriers in the second group of subcarriers information derived from a combination of the information allocated to more than one of the subcarriers in the first group. Said step may therefore comprise the step of combining the information allocated to two subcarriers of the first group into information suitable for allocation to a subcarrier of the second group. Said step of combining may comprise determining from said two subcarriers the respective signs of the real and imaginary components of the symbols allocated to these subcarriers. A mutual polarity function may thus be formed from the signs of the respective real and imaginary components of the symbols on the two said subcarriers. This mutual polarity function may then be used to modify a copy of a symbol applied to one of the two subcarriers to form a transposed symbol that is allocated to the second group of subcarriers.

Preferably, subcarriers are considered in groups of four: two subcarriers are allocated information symbols and the remaining two are allocated symbols derived from the first two symbols.

Said mutual polarity function may comprise the algebraic sign of the product of the real and imaginary parts of the information allocated to said first and second subcarriers. This measure may thus be determined by dividing said product by the absolute value of the same.

In a second aspect of the present invention, OFDM transmission apparatus comprises information allocation means for allocating information to a plurality of subcarriers, said allocation means being operable to allocate said plurality of subcarriers into two groups of subcarriers, each group comprising an even number of subcarriers and, for each group, said allocation means being operable to allocate information for transmission to a first half of said subcarriers, and including information transposition means for transposing said allocated information by means of a transposition algorithm, said allocation means being operable to allocate said transposed allocated information to a second half of the subcarriers in the group.

It will be appreciated that, in an OFDM system, (e.g. involving 64 or 128 tones) the tones do not exactly divide into equal groups of four, as the zero (D.C.) tone is not used. However, the remainder are at band edges and are in any case nulled to prevent out of band interference.

It will be appreciated that, though the invention has been characterised above as having aspects associated with a method of transmitting and with a transmitter, the invention could also be provided by means of computer implementable code for enabling a computer to become configured to perform the method as set out above.

### BRIEF DESCRIPTION OF THE DRAWINGS

Embodiments of the present invention will now be described with reference to the accompanying drawings, wherein:

FIG. 1 shows subcarriers of an OFDM signal spectrum, with frequency on the x-axis, and power on the y-axis (in an arbitrary scale);

FIG. 2 is a schematic diagram of an example communication device;

FIGS. 3a and 3b are schematic diagrams showing a transmitter and a receiver respectively according to Task Group 3a of the IEEE 802.15 standards setting body;

FIG. 3c is a schematic diagram of a transmitter in accordance with a specific embodiment of the invention;

FIG. 4 shows grouping of the first 13 subcarriers for input to a 128-point IFFT in accordance with an embodiment of the present invention;

FIG. 5 shows grouping of the inner nine subcarriers shown spectrally in accordance with an embodiment of the present invention;

FIG. 6a shows the probability distribution functions (PDF) of PAPR obtained in accordance with an embodiment of the present invention and the PDF of PAPR obtained in accordance with the method disclosed in the prior art;

FIG. 6b shows the cumulative frequency distribution (CDFs) of PAPR obtained in accordance with an embodiment of the present invention and the CDF of PAPR obtained in accordance with the method disclosed in the prior art;

FIG. 7a shows the complimentary CDFs (CCDFs) of PAPR for competing schemes when using QPSK and 128 subcarriers obtained in accordance with the method of the present invention;

FIG. 7b shows the CCDFs of PAPR for competing schemes when using 16 QAM and 128 subcarriers obtained in accordance with the method of the present invention;

FIG. 8 shows the CCDFs of PAPR for competing schemes demonstrating how relative performance gains increase as the number of tones decreases, which could provide performance gains for an OFDMA scheme obtained in accordance with the method of the present invention;

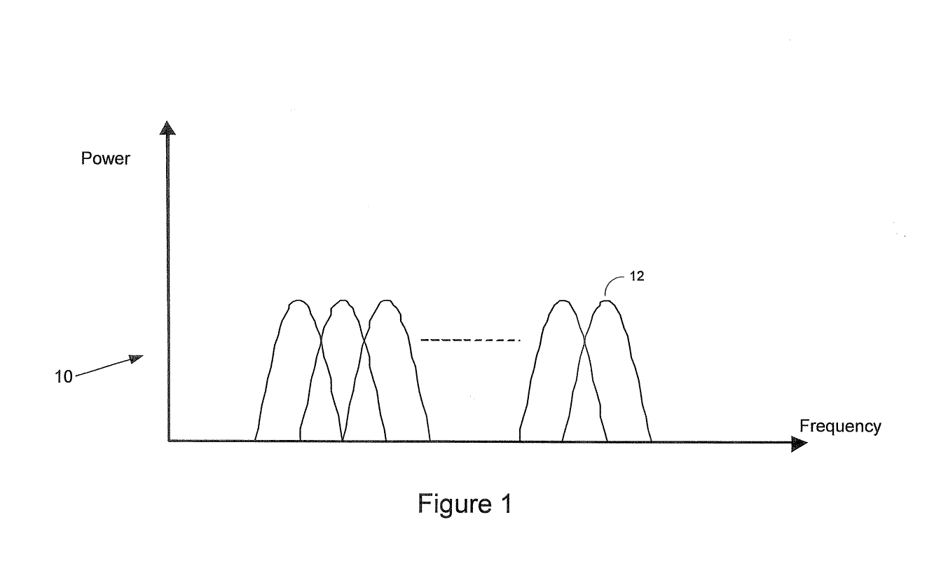

### DETAILED DESCRIPTION

Specific embodiments of the present invention will be described in further detail on the basis of the attached diagrams. It will be appreciated that this is by way of example only, and should not be viewed as presenting any limitation on the scope of protection sought.

A method and apparatus for data transmission in an OFDM system is disclosed. In the following description, a number of specific details are presented in order to provide a thorough understanding of embodiments of the present invention. It will be apparent, however, to a person skilled in the art that these specific details need not be employed to practice the present invention.

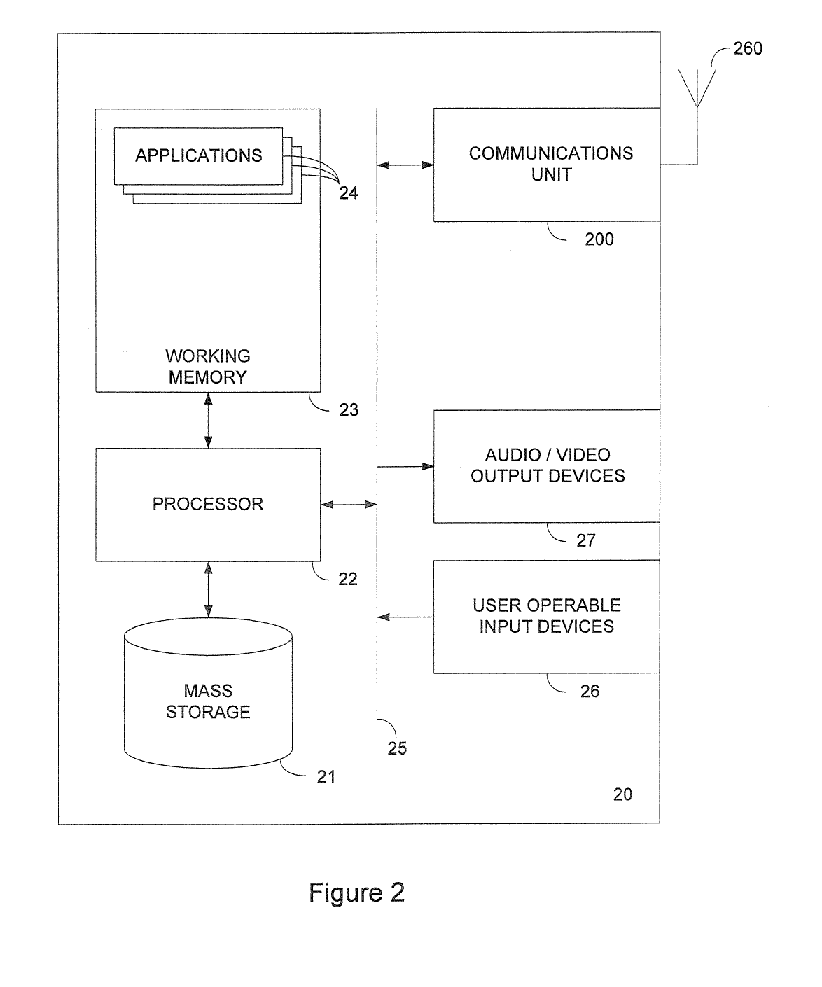

FIG. 2 illustrates schematically a laptop computer device 20 providing an example of background to the invention. The laptop 20 comprises a processor 22 operable to execute machine code instructions stored in a working memory 23 and/or retrievable from a mass storage device 21. By means of a general-purpose bus 25, user operable input devices 26 are in communication with the processor 22. The user operable input devices 26 comprise, in this example, a keyboard and a touchpad, but could include a mouse or other pointing device, a contact sensitive surface on a display unit of the device, a writing tablet, speech recognition means, haptic input means, or any other means by which a user input action can be interpreted and converted into data signals.

Audio/video output devices 27 are further connected to the general-purpose bus 25, for the output of information to a user. Audio/video output devices 27 include a visual display unit, and a speaker, but can also include any other device capable of presenting information to a user.

A communications unit 200 is connected to the general-purpose bus 25, and further connected to an antenna 260. By means of the communications unit 200 and the antenna 260, the laptop computer 20 is capable of establishing wireless communication with another device. The communications unit 200 is operable to convert data passed thereto on the bus 25 to an RF signal carrier in accordance with a communications protocol previously established for use by a system in which the laptop computer 20 is appropriate for use.

In the device 20 of FIG. 2, the working memory 23 stores user applications 24 which, when executed by the processor 22, cause the establishment of a user interface to enable communication of data to and from a user. The applications 24 thus establish general purpose or specific computer implemented utilities and facilities that might habitually be used by a user.

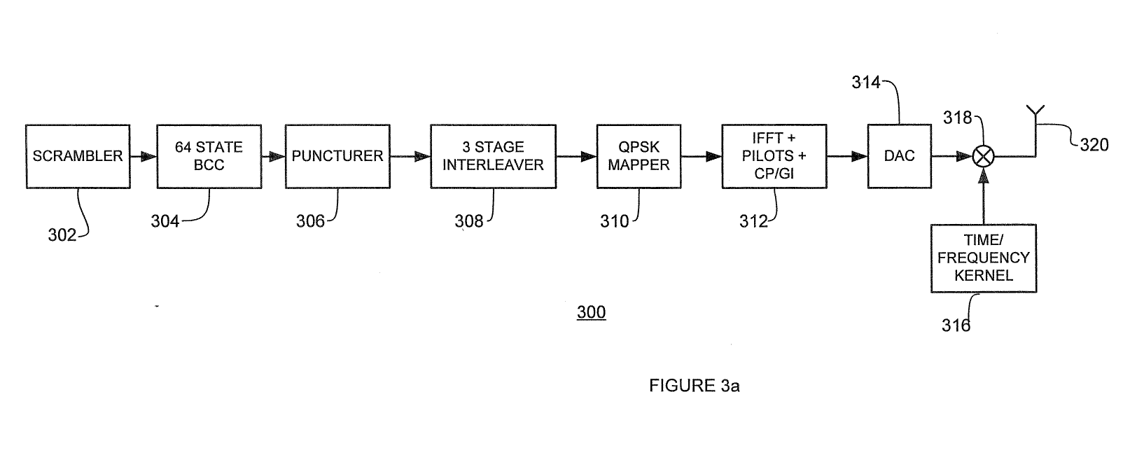

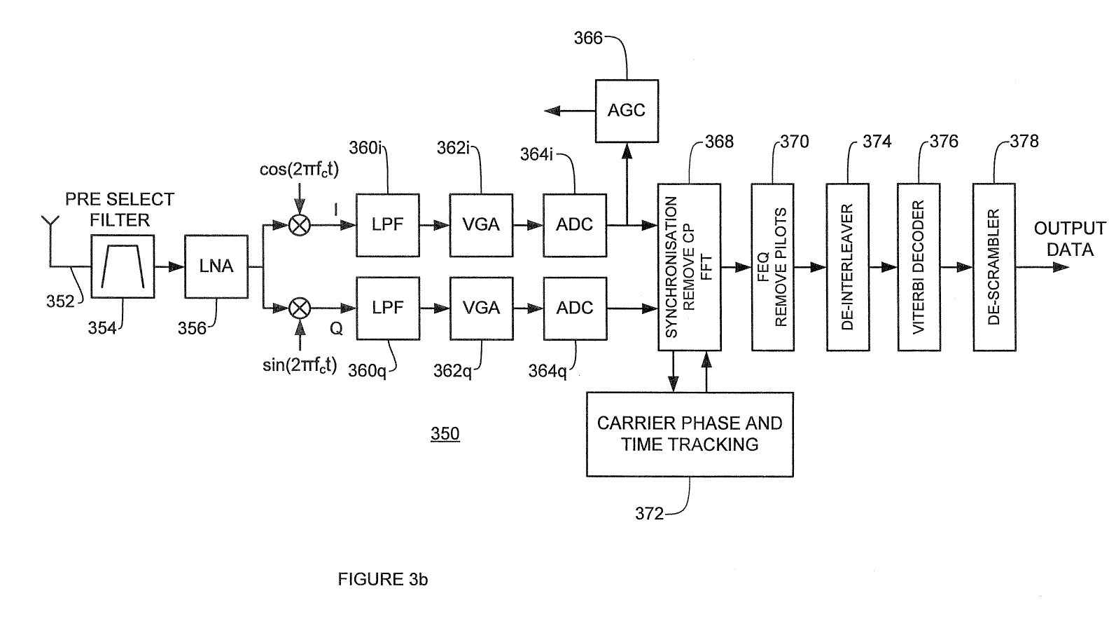

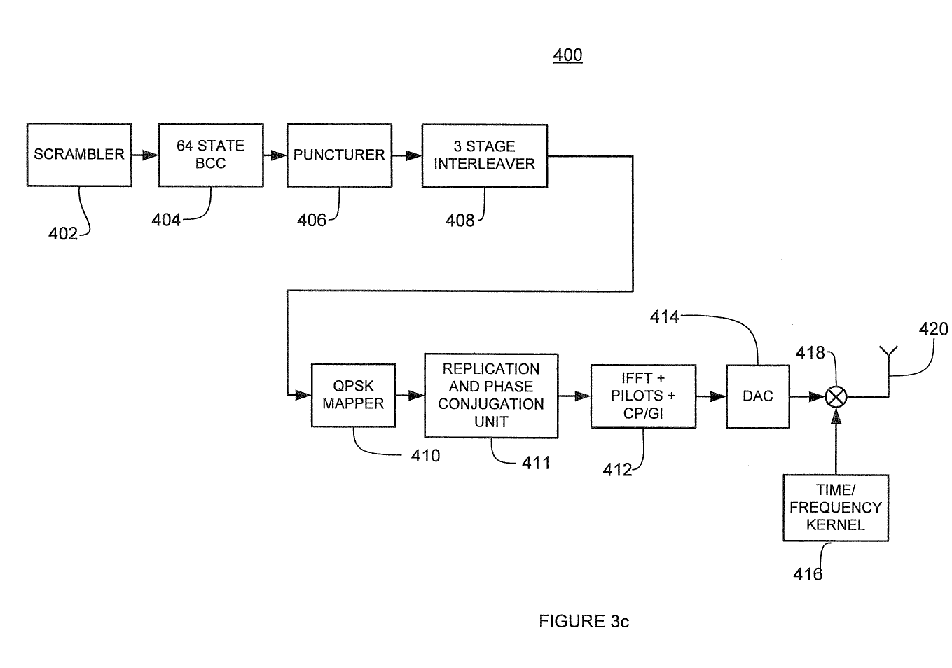

FIGS. 3a and 3b show respectively multi-band OFDM transmitter and receiver architectures that have been proposed within Task Group 3a, the body responsible for drafting the 3a amendment to the IEEE 802.15 standard. The transmitter comprises a scrambler 302, a 64-state binary convolutional code (BCC) 304, a puncturer 306, a 3-stage interleaver 308, a QPSK mapper 310, an IFFT block 312, a DAC 314, a time frequency kernel 316, a multiplier 318, and an antenna arrangement 320. Whilst the various components will be known to those skilled in the art, of interest here the QPSK mapper 310 maps incoming information bits to QPSK symbols. Each QPSK symbol is then used to modulate a sub-carrier in an OFDM symbol by the IFFT block 312. For IEEE 802.15.3a the use of 128 sub-carriers has been proposed, which are allocated to data, pilot tones, guard bands and nulled tones. Typically this leaves 100 sub-carriers for being modulated with the QPSK information symbols. Thus typically 100 QPSK information symbols are mapped to a single OFDM symbol, which is then transmitted to the receiver.

The receiver 350 comprises an antenna 352, a pre-selection filter 354, a low noise amplifier 356, quadrature and in-phase signal paths each having a receive down-converter 358 (i and q), a low pass filter 360, a variable gain amplifier 362, and an ADC 364. The outputs of the ADC's 364i and 364q are input to a Fast Fourier Transform (FFT) block 368, the output of which is coupled to a digital processing block 370 for removing pilots, frequency domain equalised (FEQ), and correction of carrier frequency offset from pilot information 372. The output is de-interleaved by block 374, the forward error correction code is decoded by a Viterbi decoder 376 and the signal is descrambled by block 378. There is also an automatic gain controller (AGC) 366 which adjusts the gain of the variable gain amplifiers 362i and 362q depending on the peak signal at the respective ADC's 364i and 364q. The incoming baseband analogue signals (in-phase and quadrature) are amplified by respective variable gain amplifiers 362 (i and q) at a gain determined by the AGC 366, and digitised by respective ADC's 364. The digitised signals (OFDM symbols) are then fed to the FFT 368 which transforms each OFDM symbol into the frequency domain and, after equalisation, enables estimates to be calculated of the complex constellation values encoded onto each of the sub-carriers (originally from a QPSK alphabet). Subsequent deinterleaving, error correction decoding, descrambling processes are then used to determine the transmitted sequence of bits.

FIG. 3c illustrates a transmitter 400 in accordance with a specific embodiment of the invention, and largely consistent with the construction of the transmitter illustrated in FIG. 3a. To that end, reference numbers for components of the transmitters correspond, but with a prefixed ‘4’ instead of ‘3’.

Further, the transmitter 400 illustrated in FIG. 3c comprises a replication and phase conjugation unit 411 interposed between the QPSK mapper 410 and the IFFT block 412. This is operable for low rate modes and is used to increase robustness and range. The QPSK mapper 410 receives a FEC coded, punctured and interleaved bit stream from preceding components or blocks in the transmitter. The replication and phase conjugation unit 411 processes incoming QPSK symbols (S1, S2, S3 . . . ) in accordance with a symbol replication and transposition process to be described below.

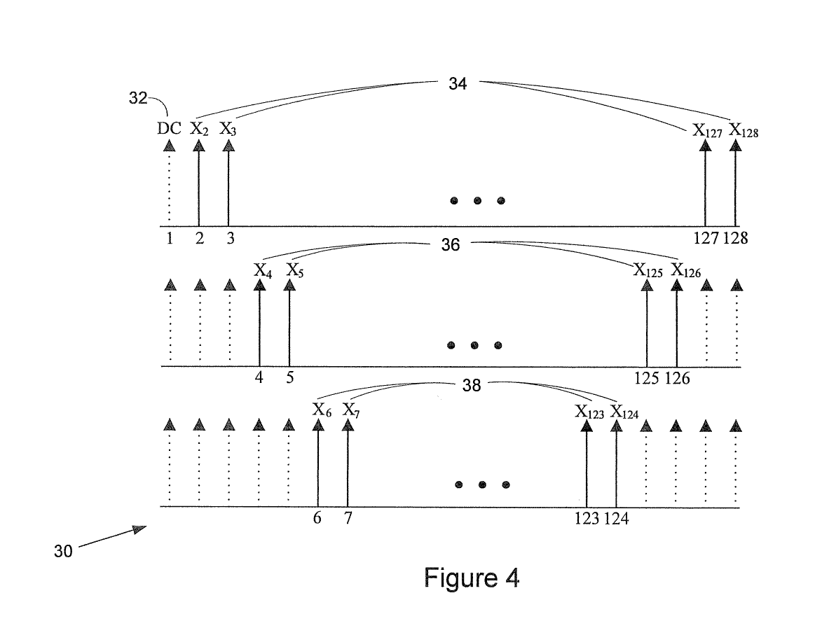

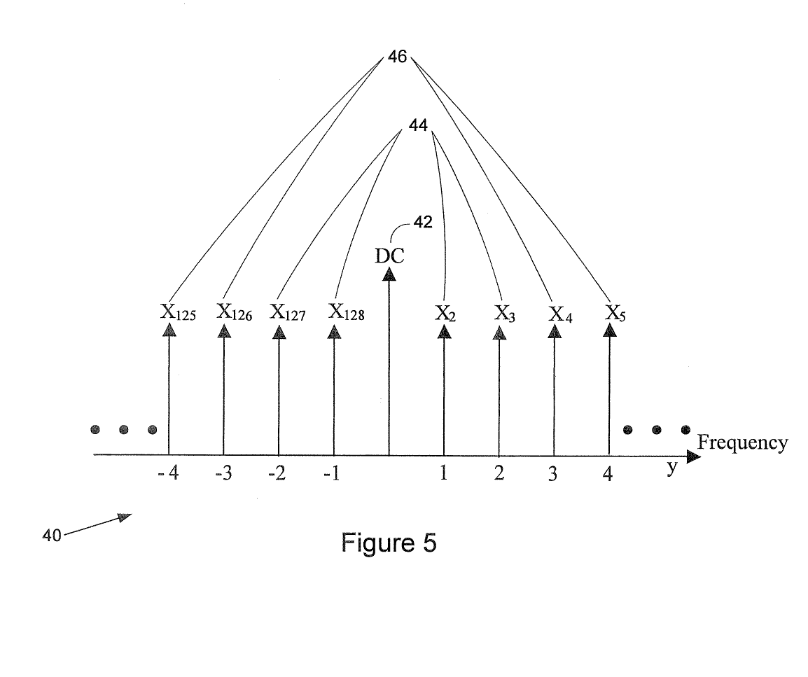

In this invention, as noted above, the subcarriers are considered in groups of four, which are symmetrically disposed in pairs about the baseband DC subcarrier 42 as shown in FIG. 5. FIG. 4 also illustrates the structure of this grouping for the first three groups 34, 36, 38 at the input to the IFFT module 412 in the transmission system 400, where the time domain signal x(t) is given by:

$$x ( t ) = {\sum }_{f = 1}^{N} {X}_{f} {e}^{\frac{2 πi}{N} ( t - 1 ) ( f - 1 )} \qquad ( 3 )$$

where X_{f} denotes the f th complex constellation value, N denotes the number of subcarriers, f denotes discrete frequency and t denotes discrete time.

It will be appreciated by the reader that FIGS. 4 and 5 are both equally valid and equivalent representations of the allocation of subcarriers. FIG. 4 shows the subcarriers ordered in subcarrier number order, with the DC baseband—subcarrier 1—at the left of the figure. FIG. 5 illustrates the same subcarriers but arranged algebraically in terms of frequency—subcarriers above X₆₄ are considered as having negative frequency.

In this example as illustrated, there are 128 subcarriers. The first half of these are allocated in a normal fashion. The allocation of the second half of the subcarriers is carried out in accordance with one of two relationships, one for odd indices, and the other for even. The relationship for odd indices is:

X_{127-2f}=−X_{2f+3}

fε[0, 30] (4)

Thus, for odd numbered subcarriers between X₆₇ and X₁₂₇, symbols are mapped to the negative of the corresponding symbol in the first subcarrier set. X₁₂₇ corresponds to X₃, X₁₂₅ to X₅, X₁₂₃ to X₇ and so on.

Then, for the even numbered subcarriers, rather than mapping in the same way from the corresponding even numbered subcarrier in the first group, a determination is made as to the mutual polarity between the even numbered symbol in the lower half and the adjacent odd numbered subcarrier in the pair. This is then applied to the value allocated to the even numbered subcarrier to further enhance the PAPR properties of the transmission. The following relationship represents this.

$${X}_{128 - 2 f} = \frac{ℜ ( {X}_{2 [ f + 1 ]} ) ℜ ( {X}_{2 f + 3} ) ( {X}_{2 [ f + 1 ]} ) ( {X}_{2 f + 3} )}{\vert ℜ ( {X}_{2 [ f + 1 ]} ) ℜ ( {X}_{2 f + 3} ) ( {X}_{2 [ f + 1 ]} ) ( {X}_{2 f + 3} ) \vert} {X}_{2 ( f + 1 )} \qquad ( 5 )$$

Essentially, this is calculating the ‘sign’ produced by the product of the real and imaginary parts of the information to be transmitted on two adjacent subcarriers in the first group, then multiplying this sign (±1) by the information on one of those subcarriers to arrive at the information to be transmitted on the even numbered subcarrier in question in the second group.

It will be appreciated that the treatment of the odd and even numbered subcarriers could be swapped in an alternative embodiment.

A simple example of this would involve QPSK symbols and 128 subcarriers (used for all modes in the IEEE802.15.3a OFDM proposal). Considering X₁₂₇ and X₁₂₈, the information to be transmitted is derived from X₂ and X₃.

In such a case,

$$\begin{matrix}{X}_{127} = - {X}_{3} \\ and & ( 6 ) \\ {X}_{128} = \frac{ℜ ( {X}_{2} ) ℜ ( {X}_{3} ) ( {X}_{2} ) ( {X}_{3} )}{\vert ℜ ( {X}_{2} ) ℜ ( {X}_{3} ) ( {X}_{2} ) ( {X}_{3} ) \vert} {X}_{2} & ( 7 )\end{matrix}$$

where [symbol] , ℑ denote the real and imaginary components respectively.

In further detail, the available symbols in QPSK can be represented as 1+i, 1−i, −1−i and −1+i, ignoring energy normalisation.

In the following table, the sign multiplier to apply to X₂ in equation 7 is set out:

Re(X₃)

| | | | |
|---|---|---|---|
| 1 | −1 | −1 | 1 |

Im(X₃)

| Re(X₂) | Im(X₂) | 1 | 1 | −1 | −1 |
|---|---|---|---|---|---|
| 1 | 1 | 1 | −1 | 1 | −1 |
| −1 | 1 | −1 | 1 | −1 | 1 |
| −1 | −1 | 1 | −1 | 1 | −1 |
| 1 | −1 | −1 | 1 | −1 | 1 |

For the more general case, for the number of subcarriers being N=2^{M}, where M≧3, equations 6 and 7 are generalised as follows:

$$\begin{matrix}{X}_{N - 2 f - 1} = - {X}_{2 f + 3} \\ and & ( 8 ) \\ {X}_{N - 2 f} = \frac{ℜ ( {X}_{2 [ f + 1 ]} ) ℜ ( {X}_{2 f + 3} ) ( {X}_{2 [ f + 1 ]} ) ( {X}_{2 f + 3} ) {X}_{2 ( f + 1 )}}{\vert ℜ ( {X}_{2 [ f + 1 ]} ) ℜ ( {X}_{2 f + 3} ) ( {X}_{2 [ f + 1 ]} ) ( {X}_{2 f + 3} ) \vert} \\ where f ∈ [ 0 , N / 4 - 2 ] . & ( 9 )\end{matrix}$$

By bounding the range of f at N/4−2, then, for N=128, the highest value of f is 30. This in turn avoids allocation of indices higher than 63.

In practice, the subcarriers at the band edges would be set to zero to ensure that the spectral mask is satisfied and this takes care of any remaining tones that cannot be grouped. Groups can also be arranged either side of pilot tones as long as the relationships for odd and even tones shown by equations 6 and 7 are preserved.

It will be appreciated that, by taking this approach, the sequence thus omits X₁, but also omits X₆₄, X₆₅ and X₆₆ which will naturally be set to zero in a working embodiment.

In a working embodiment, the input symbols would be replicated according to equations 6 and 7 by the MB-OFDM transmission system. At the receiver, the inverse operation would be performed and the pairs of resulting symbols would be combined using a method such as maximum ratio combining.

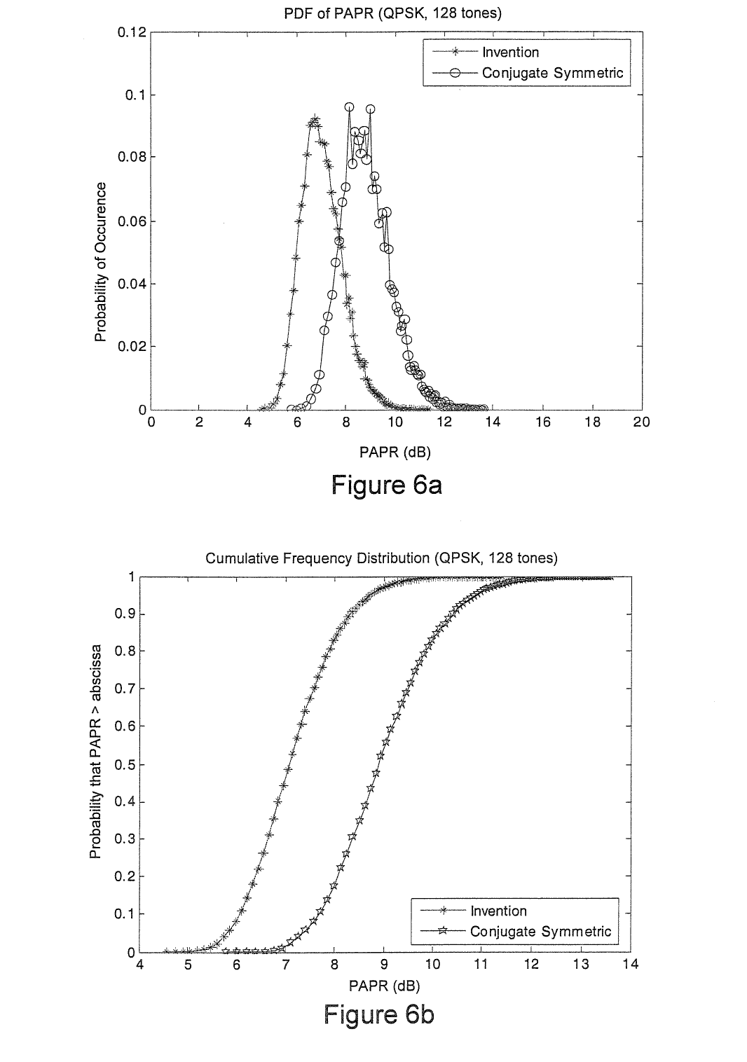

FIG. 6a and FIG. 6b show the results for QPSK constellation points and 128 subcarriers. The cumulative distribution function (CDF) curves presented in FIG. 6b show that for the conjugate symmetric approach used by for the MBOA proposal, 90% of the OFDM symbols have a PAPR of 10.3 dB or lower, whereas this is reduced to 8.2 dB or lower for the method used by this invention (2.1 dB reduction).

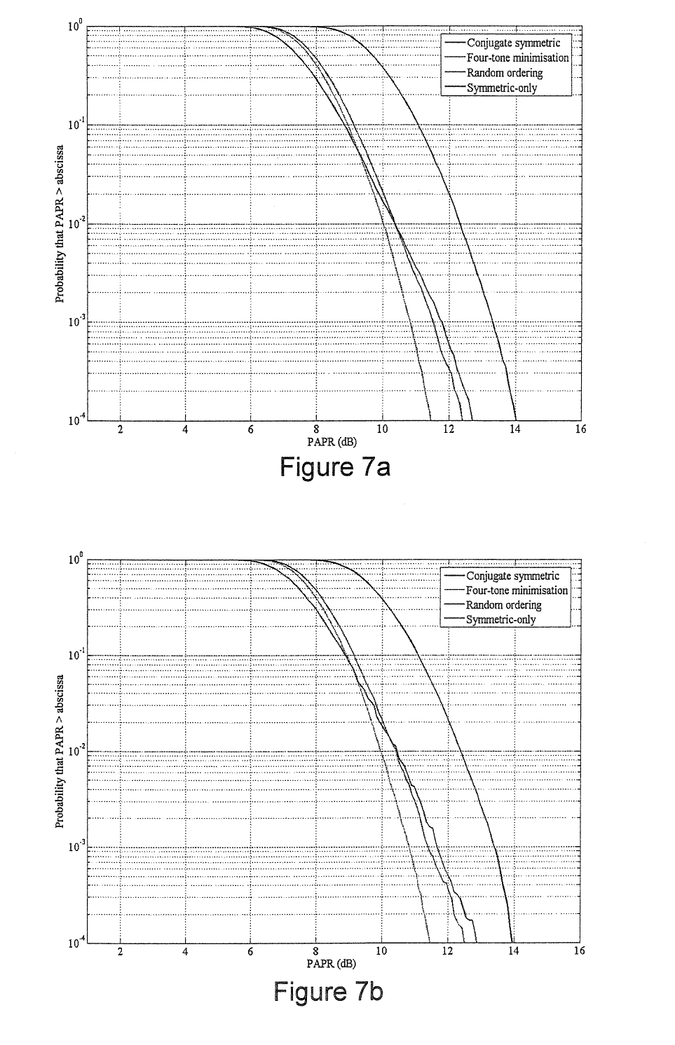

FIG. 7a shows the results expressed as a complimentary CFD (CCFD). This shows that the conjugate symmetric result adopted by the MBOA proposal is a particularly bad choice from a PAPR perspective and is worse than random tone ordering (symbols at negative frequencies are duplicated to arbitrarily assigned positive frequencies), symmetrical tone repetition (same as the conjugate symmetric method but with no phase conjugation) and the invention (termed four tone minimisation (FTM)). In this plot, the commonly accepted probability value for comparison purposes is the 10⁻³ point. The plot shows that the FTM invention is 1 dB better than the deterministic symmetrical approach and 2 dB better than conjugate symmetry.

Results for 16-QAM constellations, which are adopted for dual carrier modulation in a revision to the MBOA proposal, are shown in FIG. 7b. For the higher rate modes, conjugate symmetry is not adopted in the MBOA proposal, but there is still a worthwhile advantage in using the invention relative to the ‘randomly’ organised scheme.

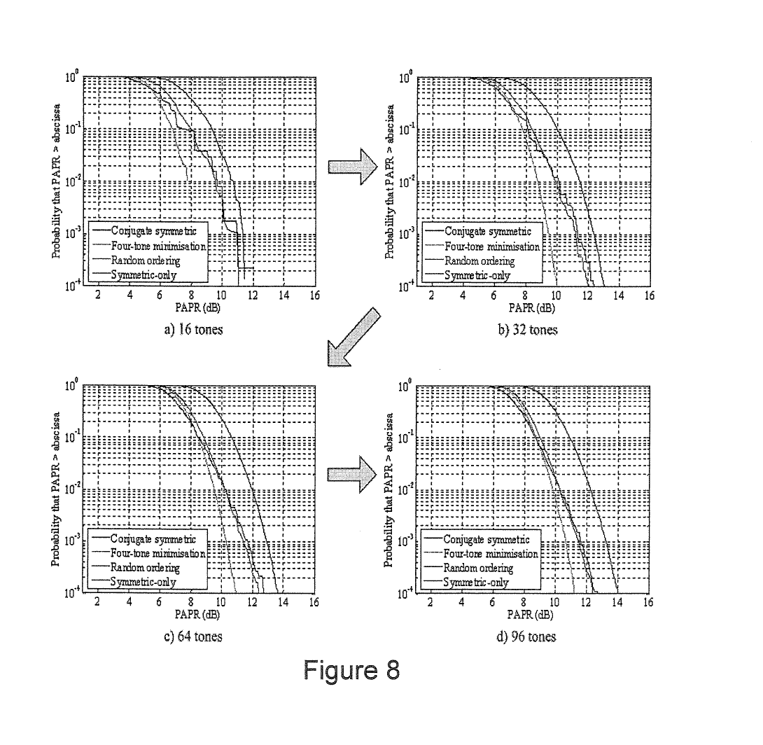

This invention has so far been described in the context of a single user UWB scenario. However, the performance gains of the scheme relative to random tone ordering diminish as the number of subcarriers increases (because the optimality of the sub-blocks becomes a smaller percentage of the whole block size). FIG. 8 illustrates this with the comparison of the performance of the scheme for 16, 32, 64 and 96 populated tones.

Hence, this arrangement could be advantageous for OFDMA where each user is assigned a subset of orthogonal tones for their transmission. If the reduced sets of tones of the individual users are organised according to this invention, then the PAPR of their signals will be close to optimal.

1. A method of generating an OFDM signal for transmission, the signal being intended for transmission over a plurality of subcarriers, the method comprising the steps of:
allocating said plurality of subcarriers into two groups of subcarriers, and:
allocating information for transmission to a first of said groups;
transposing said allocated information by means of a transposition algorithm; and
allocating to a second of said groups said transposed allocated information.

2. A method in accordance with claim 1 wherein said subcarriers are designated in the frequency domain.

3. A method in accordance with claim 2 wherein the first and second groups of subcarriers are disposed symmetrically about a DC baseband carrier in the frequency domain.

4. A method in accordance with claim 1 wherein said step of transposing comprises allocating to one of the subcarriers in the second group of subcarriers the information allocated to a first one of the subcarriers in the first group.

5. A method in accordance with claim 4 wherein the step of transposing said information from said first subcarrier comprises the step of rendering said information into its negative.

6. A method in accordance with claim 5 wherein said step of transposing comprises allocating to another of the subcarriers in the second group of subcarriers information derived from a combination of the information allocated to more than one of the subcarriers in the first group.

7. A method in accordance with claim 6 wherein said step comprises the step of combining the information allocated to two subcarriers of the first group into information suitable for allocation to a subcarrier of the second group.

8. A method in accordance with claim 7 wherein said step of combining comprises determining from said two subcarriers the respective signs of the real and imaginary components of the symbols allocated to these subcarriers, to form a mutual polarity function from the signs of the respective real and imaginary components of the symbols on the two said subcarriers.

9. A method in accordance with claim 8 and further comprising using said mutual polarity function to modify a copy of a symbol applied to one of the two subcarriers to form a transposed symbol that is allocated to the second group of subcarriers.

10. A method in accordance with claim 8 wherein said mutual polarity function comprises the algebraic sign of the product of the real and imaginary parts of the information allocated to said first and second subcarriers.

11. A method in accordance with claim 1 wherein said subcarriers are considered in groups of four, with two subcarriers being allocated information symbols and the remaining two being allocated symbols derived from the first two symbols.

12. OFDM transmission apparatus comprising information allocation means for allocating information to a plurality of subcarriers, said allocation means being operable to allocate said plurality of subcarriers into two groups of subcarriers, each group comprising an even number of subcarriers and, for each group, said allocation means being operable to allocate information for transmission to a first half of said subcarriers, and including information transposition means for transposing said allocated information by means of a transposition algorithm, said allocation means being operable to allocate said transposed allocated information to a second half of the subcarriers in the group.

13. Apparatus in accordance with claim 12 wherein said allocation means is operable to allocate said plurality of subcarriers into said first and second groups of subcarriers such that said groups are disposed symmetrically about a DC baseband carrier in the frequency domain.

14. Apparatus in accordance with claim 12 wherein said allocation means is operable to allocate to one of the subcarriers in the second group of subcarriers the information allocated to a first one of the subcarriers in the first group.

15. Apparatus in accordance with claim 14 wherein said allocation means is operable to combine the information allocated to two subcarriers of the first group into information suitable for allocation to a subcarrier of the second group.

16. Computer program product bearing computer executable program means operable to cause a computer to become configured to perform the method of any of claims 1 to 11.
